(19) United States
(12) Patent Application Publication
(10) Pub. No.: US 2022/0102825 A1
(43) Pub. Date: Mar. 31, 2022

(54) BATTERY BOX

(71) Applicant: Brunswick Corporation, Mettawa, IL (US)

(72) Inventor: Kevin T. Downey, Rockford, MI (US)

(73) Assignee: Brunswick Corporation, Mettawa, IL (US)

(21) Appl. No.: 17/471,996

(22) Filed: Sep. 10, 2021

Related U.S. Application Data
(60) Provisional application No. 63/085,105, filed on Sep. 29, 2020.

(51) Int. Cl. H01M 50/691; H01M 50/256; H01M 50/271; H01M 50/24

(52) U.S. Cl. CPC H01M 50/691; H01M 50/24; H01M 50/271; H01M 50/256

(57) ABSTRACT

A battery box includes a main housing and a cover that together define an interior of the battery box and a vent in at least one of the main housing and the cover. The vent provides fluid communication between the interior of the battery box and an atmosphere surrounding the battery box. An upper baffle is positioned in the interior of the battery box behind the vent. The upper baffle is configured to direct any liquid that enters the vent downwardly. A drain opening in the main housing allows liquid that enters through the vent to exit the main housing. A lower baffle positioned proximate the drain opening prevents liquid from entering the interior of the battery box through the drain opening.

### CROSS-REFERENCE TO RELATED APPLICATION

The present application claims the benefit of U.S. Provisional Patent Application No. 63/085,105, filed on Sep. 29, 2020, the content of which is hereby incorporated by reference in its entirety.

### FIELD

The present disclosure relates to enclosures for holding a battery, especially those meant for use in an environment where the battery box is exposed to water, such as, but not limited to, a marine environment.

### BACKGROUND

U.S. Pat. No. 6,367,646 discloses a battery box for holding a single battery that includes a one-piece container portion to receive a battery therein and a one-piece, vented lid releasably attached to the container portion through a latching arrangement. The container portion has a base with a raised portion for supporting the battery and at least one depression for receiving battery acid. Four walls extend from the base with opposed side walls including latching components. The lid has at least one extension spaced from an associated wall of the container portion adapted to accommodate battery cables or the like. Each lid vent includes a snap-on vent cover. A pair of handles attached to the container portion is attached to a pair of elongated ribs for distributing forces between the handle and the end wall. A pair of grooves in the base extend between opposed walls and are adapted to receive a strap therein on an exterior of the battery box and form the raised area and adjacent depressions in the interior. A plurality of ribs formed on the inside of the side walls define a plurality of positions for a movable partition within the battery box.

Some known battery boxes are vented by a simple pass-through hole drilled or otherwise formed in the cover of the battery box. Other known battery boxes have convoluted vent designs with tortuous paths in an attempt to prevent water from entering the battery box while still allowing gases to exit the box.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

According to one example of the present disclosure, a battery box may comprise a main housing and a cover together defining an interior of the battery box. A vent may be provided in at least one of the main housing and the cover. The vent may provide fluid communication between the interior of the battery box and an atmosphere surrounding the battery box. An upper baffle may be provided in the interior of the battery box behind the vent. The upper baffle may be configured to direct any liquid that enters the vent downwardly.

In some embodiments, a battery box may include a drain opening in the main housing and can be configured to allow liquid that enters through the vent to exit the main housing. The drain opening may be aligned with and below the vent, and the drain opening may be elevated above a floor of the main housing. The main housing may include a sump positioned below the drain opening. Additionally or alternatively, the battery box may include a lower baffle in the interior of the battery box adjacent the drain opening, the lower baffle extending upwardly. The lower baffle may be configured to prevent liquid from entering the interior of the battery box through the drain opening.

In some embodiments, the upper baffle may include a first upper baffle portion and a second upper baffle portion arranged in an angled relationship with the first upper baffle portion. The first upper baffle portion may be spaced apart from the second upper baffle portion. The vent may include a plurality of longitudinal slots, and at least a portion of the upper baffle may be in an angled relationship with the plurality of longitudinal slots. Additionally or alternatively, the upper baffle may extend downwardly from an inner surface of the cover. The upper baffle may have a lower edge that is positioned below a bottommost extent of the vent.

In some embodiments, the battery box may comprise a second vent in at least one of the main housing and the cover and a second drain opening in the main housing. The second vent may provide fluid communication between the interior of the battery box and the atmosphere surrounding the battery box. The second drain opening may be configured to allow liquid that enters through the second vent to exit the main housing. In such an embodiment, the battery box may include at least one of a third baffle proximate the second vent configured to direct any liquid that enters the second vent downwardly and a fourth baffle adjacent the second drain opening configured to prevent liquid from entering the battery box through the second drain opening.

In some embodiments, the cover of the battery box may include a battery retention panel removably secured to the main housing and configured to retain a battery in the interior of the battery box, and an access panel hingedly attached to the main housing and movable to an open position to provide access to the interior of the battery box without removing the battery retention panel.

According to another example of the present disclosure, a battery box may comprise a main housing and a cover together defining an interior of the battery box. A vent may be positioned in at least one of the main housing and the cover, and the vent may provide fluid communication between the interior of the battery box and an atmosphere surrounding the battery box. A drain opening may be positioned in the main housing and can be configured to allow liquid that enters through the vent to exit the main housing. A lower baffle may be positioned proximate the drain opening and configured to prevent liquid from entering the interior of the battery box through the drain opening.

In some embodiments, the battery box may include an upper baffle configured to redirect any liquid that enters the vent downwardly. The upper baffle may be connected to at least one of the cover and a side of the main housing. Additionally or alternatively, the lower baffle may extend upwardly from a floor of the main housing to an upper edge of the lower baffle that is positioned above an uppermost extent of the drain opening.

### BRIEF DESCRIPTION OF DRAWINGS

Examples of battery boxes are described with reference to the following Figures. The same numbers are used throughout the Figures to reference like features and like components.

FIG. 1 is a front perspective view of a first example of a battery box according to the present disclosure.

FIG. 2 is a side perspective view thereof.

FIG. 3 is a cross-sectional view of a portion of the cover of the battery box.

FIG. 4 is a top perspective view of a vent on the cover of the battery box, showing internal features.

FIG. 5 is a cross-sectional view of a main housing of the battery box.

FIG. 6 is a top perspective view of the main housing with the cover removed.

FIG. 7 is a cross-sectional view showing the flow of water through the battery box of FIGS. 1-6.

FIG. 8 is a front view of a second example of a battery box according to the present disclosure.

FIG. 9 is a partial bottom perspective view of the battery box of FIG. 8.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless otherwise specified or limited, the phrases “at least one of A, B, and C,” “one or more of A, B, and C,” and the like, are meant to indicate A, or B, or C, or any combination of A, B, and/or C, including combinations with multiple instances of A, B, and/or C. Likewise, unless otherwise specified or limited, the terms “mounted,” “connected,” “linked,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “bottom,” “front,” “back,” “left,” “right,” “lateral” or “longitudinal” features is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally, use of the words “first,” “second”, “third,” etc. is not intended to connote priority or importance, but merely to distinguish one of several similar elements from another.

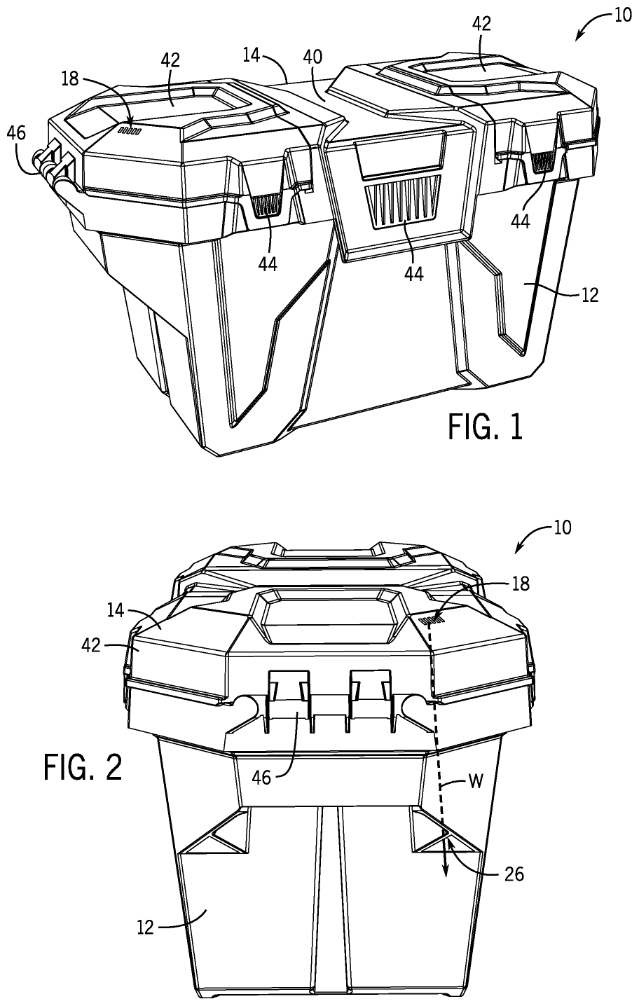

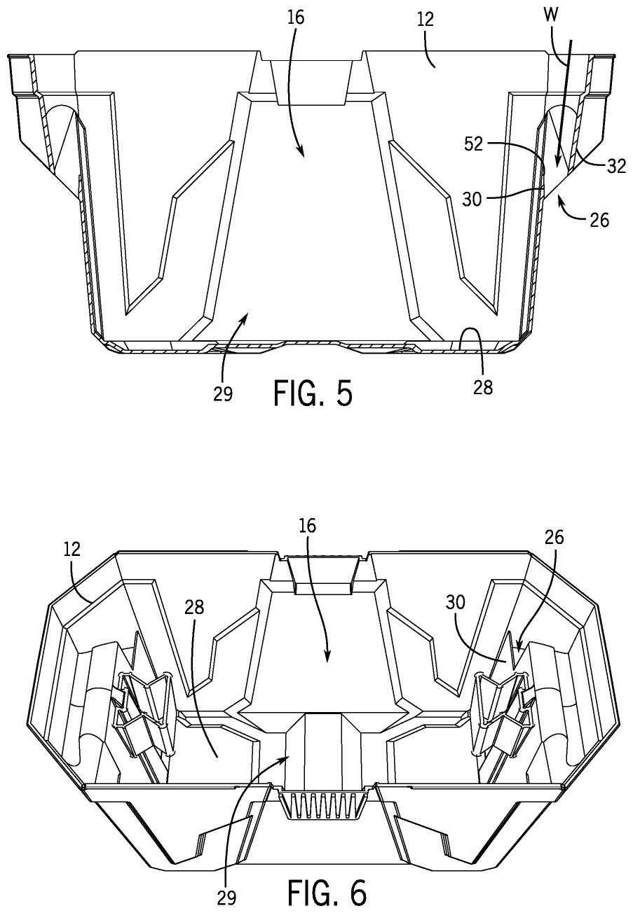

FIGS. 1 and 2 show a battery box 10 comprising a main housing 12 and a cover 14 together defining an interior 16 (FIGS. 5, 6) of the battery box 10. Although the cover 14 is shown as being on top of the main housing 12, it should be understood that the cover 14 could be on one or more sides or on the bottom of the main housing 12. Some embodiments of a cover 14 may include plurality of individually removable and/or openable sections. In the illustrated embodiments, for example, the cover 14 includes a removable battery retention panel 40 and two access panels 42 that are wingedly connected to the lateral sides of the main housing 12. The battery retention panel 40 extends across the top of the main housing 12 and is removably secured thereto by snap-fit connectors 44 on opposing front and back sides of the main housing 12. When secured to the main housing 12, the battery retention panel 40 is configured to retain a battery in the interior 16 of the battery box 10.

The access panels 42 are each secured to a lateral side of the main housing 12 by a hinge 46, which may allow a user to selectively move the access panels 42 between a closed position and an open position. In the closed position, the access panels 42 extend from a respective lateral side of the main housing 12 to the battery retention panel 40 so that the opening into the main housing 12 is covered. Snap fit connections 44 may be positioned on at least one of the front side and the back side of the main housing 12 to retain the access panels 42 in a closed position. When the access panels 42 are moved into an open position, the interior 16 of the battery box 10 is accessible. This may be useful, for example, in order to provide access to the terminals of the battery without removing the battery retention panel 40.

Some embodiments of a battery box 10 may include a cover configured differently than the illustrated covers. For example, a cover may include an additional access panel and/or battery retention panel, or the access panel(s) or battery retention panel may be omitted. In some embodiments, the access panels may be fully removable without a hinged connection to the main housing. Additionally or alternatively, at least one of the battery retention panel and the access panel(s) may be secured to the main housing with a locking mechanism that is different than a snap-fit connector, such as a twist lock mechanism or a different type of mechanical fastener.

With continued reference to the figures, the battery box 10 may be provided with a vent 18 in at least one of the main housing 12 and the cover 14. The vent 18 may be configured to provide fluid communication between the interior 16 of the battery box 10 and an atmosphere surrounding the battery box 10. Venting a battery box is helpful to allow hydrogen and other gases to escape the enclosure, as well as to cool the battery and extend its life. In the illustrated embodiments, a vent 18 is positioned in at least one of the access panels 42 of the cover 14 proximate a peripheral edge of the battery box 10. Additionally or alternatively, some embodiments may include a vent 18 that is positioned in at least one of a different location on the access panel 42, the battery retention panel 40, and the main housing 12, especially if the cover 14 is located elsewhere than on the top of the main housing 12. For example, an embodiment of a battery box with a cover configured to be secured to a side of the main housing may include a vent formed in a top side the main housing.

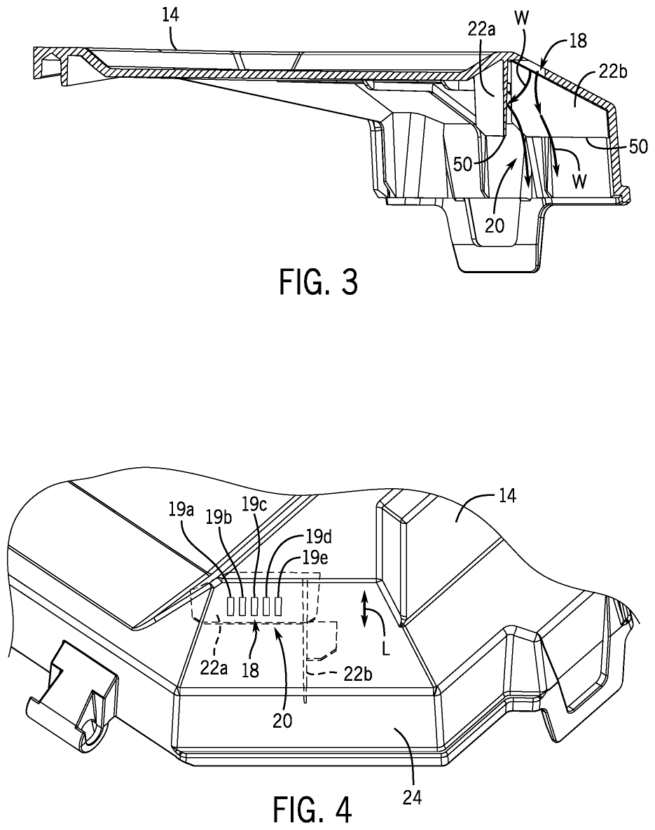

It is known that water can enter a battery box via a vent, such as from rain or from a splash if the battery box is used in a marine environment. Through research and experimentation in the relevant field, the present inventor has developed features of the battery box 10 that prevent water that enters via the vent 18 in a trickle or a rush from contacting the battery terminals. A series of internal baffles 20, 30 (FIGS. 3, 5) may be positioned within the interior 16 of the battery box 10 and can be configured to redirect water away from the battery terminals. At least one of the baffles 20, 30 may be configured to direct water towards a drain opening 26 so that the water exits the battery box 10 without contacting the battery.

As shown in FIGS. 3 and 4, the battery box 10 may include an upper baffle 20 that is provided in the interior 16 of the battery box 10 behind the vent 18. The upper baffle 20 may be configured to direct any liquid that enters the vent 18 downwardly, thereby inhibiting the lateral and longitudinal movement of liquid towards the battery. In the illustrated embodiments, the upper baffle 20 comprises two upper baffle portions 22a and 22b oriented at an angle to one another and extending downwardly from the upper inner surface of the cover 14 such that a lower edge 50 of each upper baffle portion 22a, 22b of the upper baffle 30 is located below the bottommost extent of the vent 18. The vent 18 comprises a series of slots 19a-e having openings elongated in a longitudinal direction L, and at least a portion of the upper baffle 20 is in an angled relationship with the plurality of longitudinal slots 19a-e. For example, the first upper baffle portion 22a is oriented non-parallel to the longitudinal direction L of the slots 19a-e, while the second upper baffle portion 22b is oriented parallel to the longitudinal direction L of the slots 19a-e. Some embodiments, however, may include a vent with a different opening pattern.

Although both upper baffle portions 22a, 22b are shown as being connected to the upper inside surface of the access panel 42 of the cover 14, at least one of the upper baffle portions 22a, 22b may be connected to a different portion of the battery box 10. For example, the second upper baffle portion 22b could alternatively or additionally be connected to the inside surface of the lip 24 of the cover 14. Further still, some embodiments may be configured with at least one upper baffle portion that is connected to the battery retention panel 40 or to a side wall of the main housing 12.

When water enters the vent 18, the upper baffle portions 22a and/or 22b will deflect the flow downwardly, as shown by the arrows W in FIG. 3. The first upper baffle portion 22a is configured to restrict movement of the water in a longitudinal direction relative to the slots 19a-e, while the second upper baffle portion 22b is configured to restrict movement of the water in a lateral direction relative to the slots 19a-e. In some embodiments, however, at least one of the upper baffle portions 22a, 22b may be arranged in a different orientation relative to the vent 18 such that the upper baffle portion(s) 22a, 22b restrict flow of the water in a different direction or combination of directions.

Some embodiments of a battery box may include an upper baffle configured differently than those of the illustrated embodiment. For example, the upper baffle may include at least one additional portion, such as an upper baffle portion positioned opposite the second upper baffle portion 22b so that the upper baffle extends around three sides of the vent 18. While the illustrated upper baffle portions 22a, 22b are generally planar, at least one upper baffle portion may be curved and/or have multiple segments in an angled relationship with each other. Additionally or alternatively, the upper baffle portions may be formed as a single piece, as opposed to the present embodiment, in which the first upper baffle portion 22a is spaced apart from the second upper baffle portion 22b. For example, a battery box may include an upper baffle with a single upper baffle portion that curves around the vent 18 in an arc.

As previously mentioned, some embodiments of a battery box 10 may include a drain opening formed in the floor 28 and/or sides of the main housing 12. For example, referring to FIGS. 5 and 6, a drain opening 26 is formed in the main housing 12 and is configured to allow liquid that enters through the vent 18 to exit the main housing 12. As shown in FIG. 2, the drain opening 26 is aligned with and below the vent 18 such that water flows into and out of the battery box 10 as shown by the arrow W. This may be useful, for example, so that the water flows to the drain opening 26 without baffles or other structural elements forming a closed passageway from the vent 18 to the drain opening 26. The drain opening 26 is formed in a side wall of the main housing 12 and is elevated above the floor 28 of the main housing 12. This way, the water that enters through the vent 18 has less far to flow before it exits the drain opening 26, thereby reducing the possibility of water traveling into the interior 16 and contacting the battery. Additionally, the elevated position of the drain opening 26 allows for the main housing 12 to form a “sump” 29 of sorts below the drain opening 26 to contain any battery acid that leaks from the battery inside the battery box 10.

In some embodiments, the battery box 10 may include at least one additional baffle positioned proximate the drain opening 26. In the illustrated embodiments, a lower baffle 30 is provided in the interior 16 of the battery box 10 adjacent the drain opening 26. The lower baffle 30 may be generally planar and extends upwardly from the floor 28 of the main housing 12. This lessens the gap between the upper baffle 20 and the drain opening 26, thereby reducing the chance that water entering via the vent 18 will enter the interior 16 of the battery box 10 and contact the battery. The lower baffle 30 extends upwardly at least as far as a downwardly extending outer wall 32 defining the exit of the drain opening 26, so that an upper edge 52 of the lower baffle 30 is located above the uppermost extent of the drain opening 26 (i.e., at lowermost edge of outer wall 32). As such, rain or splashing water cannot enter the interior 16 of the battery box 10 via the drain opening 26.

Some embodiments of a battery box may include a differently configured lower baffle. For example, a lower baffle may be formed at an angle relative to the floor 28 of the main housing 12 so that the lower baffle tapers inwards towards the battery. This may be useful, for example, to redirect water that has traveled in the direction of the battery back towards the drain opening 26. Additionally or alternatively, a lower baffle may include a plurality of baffle portions arranged around the drain opening 26. A lower baffle may be curved and/or have multiple segments in an angled relationship with each other. Further still, a battery box may be configured with a lower baffle with an upper edge that is located below the top of the drain opening 26, and/or at least one lower baffle may be omitted.

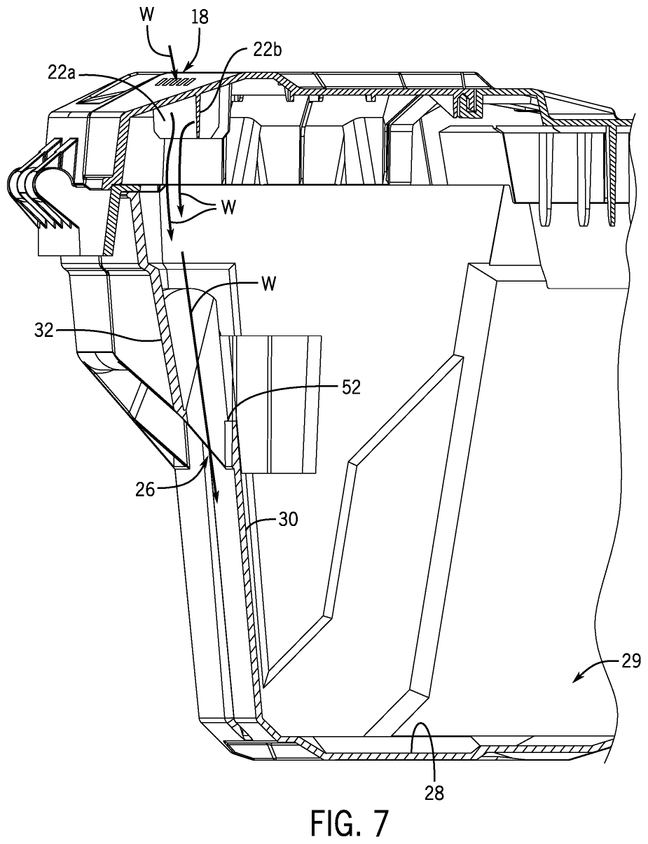

FIG. 7 shows the flow of water into the battery box 10 via the vent 18, contacting one or both of the upper baffle portions 22a, 22b, and exiting via the drain opening 26.

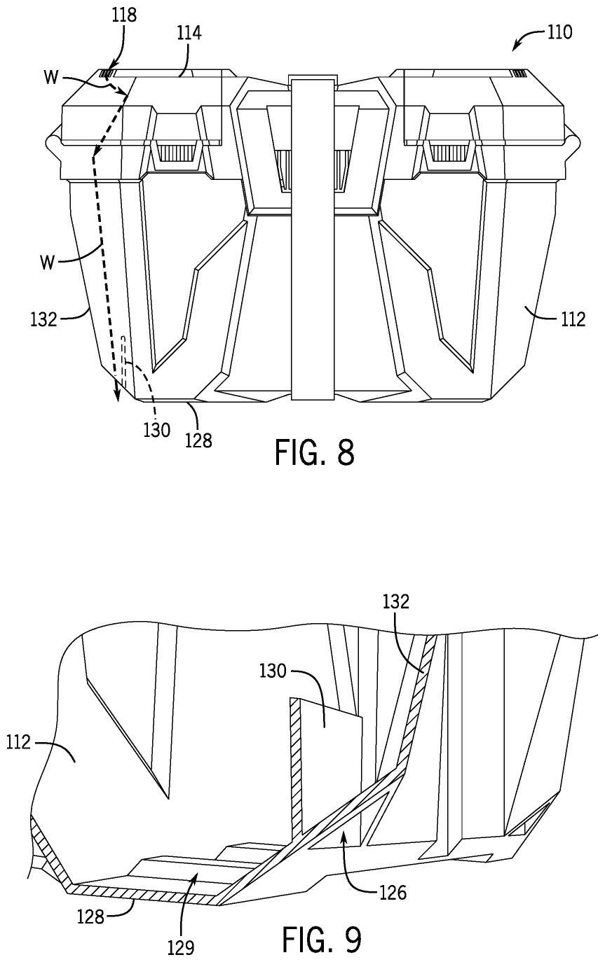

FIGS. 8 and 9 show another example of a battery box 110, in which the location of the drain opening 126 is different than that shown in FIGS. 2, 5, and 6. Here, the drain opening 126 is located closer to the floor 128 of the main housing 112 than in the first example. The lower baffle 130 extends upwardly from the floor 128 of the main housing 112 behind the drain opening 126 and acts as a divider between the interior 116 of the battery box 110 and the drain opening 126, lessening the chance that battery acid could leak from the battery box 110 and preventing rain or splashing water from entering via the drain opening 126. In some embodiments, the lower baffle 130 may be connected to the outer wall 132 of the main housing 112 to provide a sump 129 behind the lower baffle 130 and below the drain opening 126. In other embodiments, however, the lower baffle 130 may be disconnected from the outer wall 132 of the main housing 112.

Referring to FIGS. 8 and 9, an example of a path for water entering at the vent 118 and exiting at the drain opening 126 is shown by the arrows W. Although it is not depicted in FIGS. 8 and 9, it should be understood that battery box 110 may include an upper baffle similar to the upper baffle 30 illustrated in FIGS. 3 and 4.

Although the present examples show only one vent and drain opening combination, it would be understood that some embodiments of a battery box may include at least one additional vent and drain opening combination. For example, an access panel may include a first vent positioned proximate a first corner and a second vent positioned proximate a second corner of the access panel, with corresponding drain openings provided below each vent. Additionally or alternatively, a battery box may include a first vent in a first access panel and a second vent positioned in a second access panel or in the battery retention panel. The battery box may include an additional upper baffle corresponding to each additional vent, and/or an additional lower baffle corresponding to each additional drain opening.

In some embodiments, a battery box may include at least one additional vent and an associated upper baffle without an additional drain opening. In such an embodiment, water entering the battery box through a first vent and a second vent may be directed to a single drain opening by at least one of an upper baffle, a lower baffle, and any other portion of the main housing. Additionally or alternatively, some embodiments of a battery box may include at least one additional baffle configured to redirect water away from the battery and/or towards a drain opening. For example, a third baffle may be positioned in the main housing between the upper baffle 20 and the lower baffle 30, 130. In still other examples, at least one drain opening may be positioned in the floor 28, 128 of the housing 12, 112 rather than elevated above the floor.

In the present description, certain terms have been used for brevity, clarity, and understanding. No unnecessary limitations are to be implied therefrom beyond the requirement of the prior art because such terms are used for descriptive purposes only and are intended to be broadly construed. The different systems described herein may be used alone or in combination with other systems. Various equivalents, alternatives, and modifications are possible within the scope of the appended claims.

What is claimed is:

1. A battery box comprising:
a main housing and a cover together defining an interior of the battery box;
a vent in at least one of the main housing and the cover, the vent providing fluid communication between the interior of the battery box and an atmosphere surrounding the battery box; and
an upper baffle in the interior of the battery box behind the vent, the upper baffle configured to direct any liquid that enters the vent downwardly.

2. The battery box of claim 1, further comprising a drain opening in the main housing configured to allow liquid that enters through the vent to exit the main housing.

3. The battery box of claim 2, wherein the drain opening is aligned with and below the vent.

4. The battery box of claim 2, wherein the drain opening is elevated above a floor of the main housing.

5. The battery box of claim 4, wherein the main housing includes a sump positioned below the drain opening.

6. The battery box of claim 2, further comprising a lower baffle in the interior of the battery box adjacent the drain opening, the lower baffle extending upwardly.

7. The battery box of claim 6, wherein the lower baffle is configured to prevent liquid from entering the interior of the battery box through the drain opening.

8. The battery box of claim 1, wherein the upper baffle includes a first upper baffle portion and a second upper baffle portion arranged in an angled relationship with the first upper baffle portion.

9. The battery box of claim 8, wherein the first upper baffle portion is spaced apart from the second upper baffle portion.

10. The battery box of claim 1, wherein the vent includes a plurality of longitudinal slots, and at least a portion of the upper baffle is in an angled relationship with the plurality of longitudinal slots.

11. The battery box of claim 1, wherein the upper baffle extends downwardly from an inner surface of the cover.

12. The battery box of claim 11, wherein the upper baffle has a lower edge that is positioned below a bottommost extent of the vent.

13. The battery box of claim 2, further comprising:
a second vent in at least one of the main housing and the cover, the second vent providing fluid communication between the interior of the battery box and the atmosphere surrounding the battery box; and
a second drain opening in the main housing configured to allow liquid that enters through the second vent to exit the main housing.

14. The battery box of claim 13, further comprising at least one of a second baffle proximate the second vent configured to direct any liquid that enters the second vent downwardly and a third baffle adjacent the second drain opening configured to prevent liquid from entering the battery box through the second drain opening.

15. The battery box of claim 1, wherein the cover includes a battery retention panel removably secured to the main housing and configured to retain a battery in the interior of the battery box and an access panel hingedly attached to the main housing and movable to an open position to provide access to the interior of the battery box without removing the battery retention panel.

16. A battery box comprising:
a main housing and a cover together defining an interior of the battery box;
a vent in at least one of the main housing and the cover, the vent providing fluid communication between the interior of the battery box and an atmosphere surrounding the battery box;
a drain opening in the main housing configured to allow liquid that enters through the vent to exit the main housing; and
a lower baffle positioned proximate the drain opening and configured to prevent liquid from entering the interior of the battery box through the drain opening.

17. The battery box of claim 16, further comprising an upper baffle configured to redirect any liquid that enters the vent downwardly.

18. The battery box of claim 17, wherein the upper baffle is connected to at least one of the cover and a side of the main housing.

19. The battery box of claim 16, wherein the lower baffle extends upwardly from a floor of the main housing to an upper edge of the lower baffle that is positioned above an uppermost extent of the drain opening.
